(19) United States
(12) Patent Application Publication
(10) Pub. No.: US 2012/0014656 A1
(43) Pub. Date: Jan. 19, 2012

(54) PATCH PANEL FOR AN OPTICAL DISTRIBUTOR

(75) Inventors: Jörg Adomeit, Berlin (DE); Reinhard Feltgen, Alstorf (DE)

(73) Assignee: ADC GmbH, Berlin (DE)

(21) Appl. No.: 13/256,639

(22) PCT Filed: Dec. 16, 2009
(86) PCT No.: PCT/EP2009/009034

§ 371 Date: Sep. 15, 2011

(30) Foreign Application Priority Data
Mar. 16, 2009 (DE) 10 2009 013 299.6

(51) Int. Cl. G02B 6/46

(52) U.S. Cl. 385/135

(57) ABSTRACT

The invention relates to a patch panel (1) for an optical distributor, comprising a housing (2) having a front plate disposed on the front side thereof and having couplings (10) or adapters for optical plug connectors, wherein a second front plate (12) having couplers (19) or adapters for optical plug connectors is disposed in front of the front plate (9).

The invention relates to a patch panel for an optical distribution frame, comprising a housing on whose front face a front panel is arranged having couplings or adapters for optical plug connectors.

Optical distribution frames (ODF) comprise a frame and a similar holder in which patch panels can be arranged one above the other. In this case, there is a requirement for a high packing density with a good handling capability. In this case, the height represents a restriction, that is to say the number of patch panels which can be installed one above the other is restricted.

The invention is based on the technical problem of providing a patch panel which has a higher packing density.

The technical problem is solved by the subject matters having the features of claim 1. Further advantageous refinements of the invention are specified in the dependent claims.

For this purpose, the patch panel for an optical distribution frame comprises a housing on whose front face a front panel is arranged having couplings or adapters for optical plug connectors, with a second front panel having couplings or adapters for optical plug connectors being arranged in front of the front panel, preferably with the second front panel being arranged on a plane parallel to the plane of the first front panel, furthermore preferably with the second front panel having the capability to pivot with respect to the first front panel. This virtually doubles the packing density, with the increase in the physical space forward toward the front face being less critical. In principle, there is no need for the second front panel to be able to pivot, but the two front panels would then have to be at a sufficient distance from one another to allow the couplings of the first front panel to be accessible. This is simplified by designing the second front panel such that it can pivot, thus making it possible to correspondingly minimize the distance between the front panels.

In one preferred embodiment, the first front panel is attached to a cassette, with the cassette being arranged on the housing such that it can be moved or pivoted. By way of example, this means that the couplings or adapters of the first front panel are accessible from the rear face, thus allowing optical plugs to be connected or cleaned. Furthermore, further devices which are arranged to the rear are also accessible.

In a further preferred embodiment, the cassette has a base plate, with optical distribution frame and/or connecting elements, in particular such as splicing cassettes, being arranged on the base plate.

In a further preferred embodiment, the base plate is lengthened over the front panel such that a stowage surface is formed in front of the first front panel. In this case, the stowage surface is primarily used to hold the fibers or cables of the optical plugs which have been inserted from the front face into the couplings or adapters, so that they do not hang down. In this case, the base plate, in particular in front of the front panel, need not be in the form of a continuous plate but may also have holes or slots, or else, for example, may be in the form of a wire mesh.

In a further preferred embodiment, an element which is in the form of a plate and runs parallel to the base plate is arranged on an upper edge of the second front panel. The rearward fibers or cables of the second front panel can be attached to this element which is in the form of a plate. It is also possible to pass the pivoting bearing through this element which is in the form of a plate. In addition, the element which is in the form of a plate acts as a cover for the couplings or adapters of the first front panel.

In a further preferred embodiment, a further element which is in the form of a plate is arranged on a lower edge of the second front panel and extends parallel to the first element which is in the form of a plate, in the direction of the front face. This once again provides a stowage area for the fibers or cables. With respect to the configuration of the first and/or of the second element which is in the form of a plate, reference can be made to the base plate, that is to say they may also be perforated, slotted or provided with other openings.

In a further preferred embodiment, the first and the second front panel each have the same height and are coincident, with the couplings or adapters of the second front panel being arranged offset in height with respect to the couplings or adapters of the first front panel. In this case, the two front panels preferably have a height of one height unit. In this case, it should be noted that, in principle, it is also possible for the front panels each to have a height of multiples of the height unit and to have a plurality of rows of couplings or adapters, or else to have a height of a fraction of one height unit. As a result of the height offset between the couplings or adapters of the first front panel, the fibers or cables of the rearward plugs of the second front panel run on a plane which is shifted parallel to the fibers or cables of the front-face plugs of the first front panel, as a result of which they do not interfere with them as much.

In a further preferred embodiment, the fibers or cables of the rearward plugs of the second front panel are passed through an opening in the first front panel or through an opening between the first front panel and the side wall, from where they can be passed, for example, to the distribution frame elements and/or connecting elements on the base plate.

In a further preferred embodiment, the fibers are fixed between the couplings or adapters as far as a rotation point of a pivoting bearing.

In a further preferred embodiment, the fibers are fixed behind the first front panel, such that the fibers can move only in the area of the rotation point, in order to compensate for the pivoting movement.

The invention will be explained in more detail in the following text with reference to one preferred exemplary embodiment. In the figures:

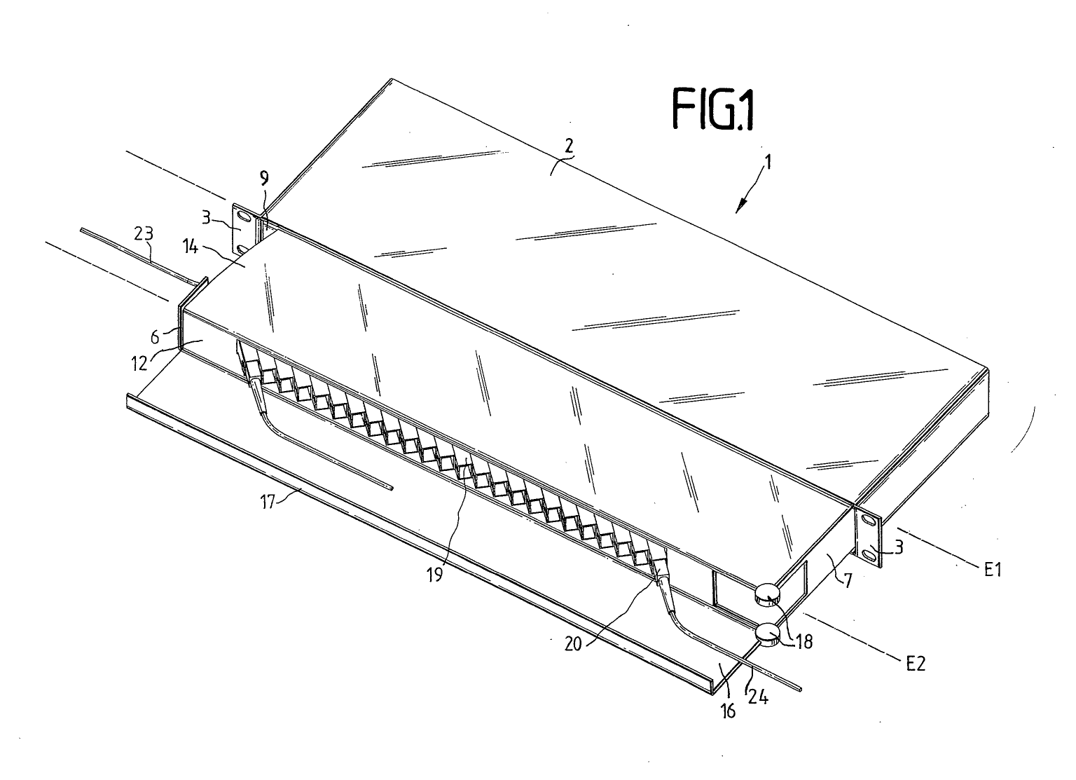

FIG. 1 shows a perspective front view of a patch panel for an optical distribution frame,

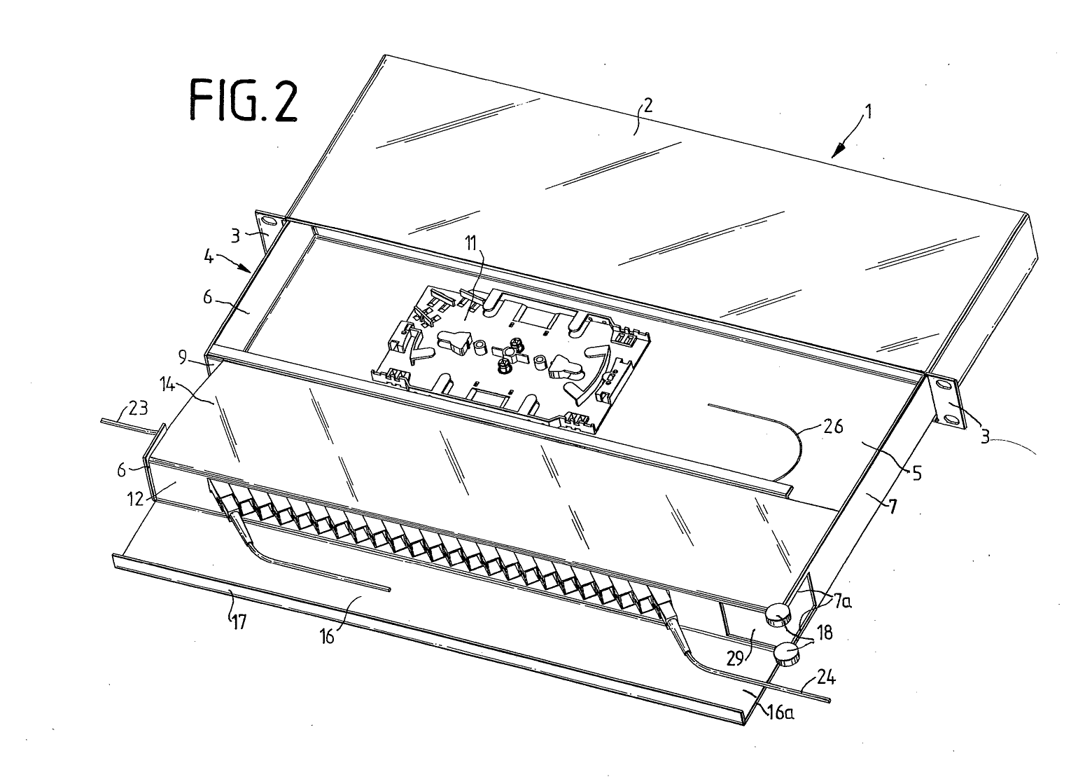

FIG. 2 shows a perspective front view of the patch panel with a cassette pulled out,

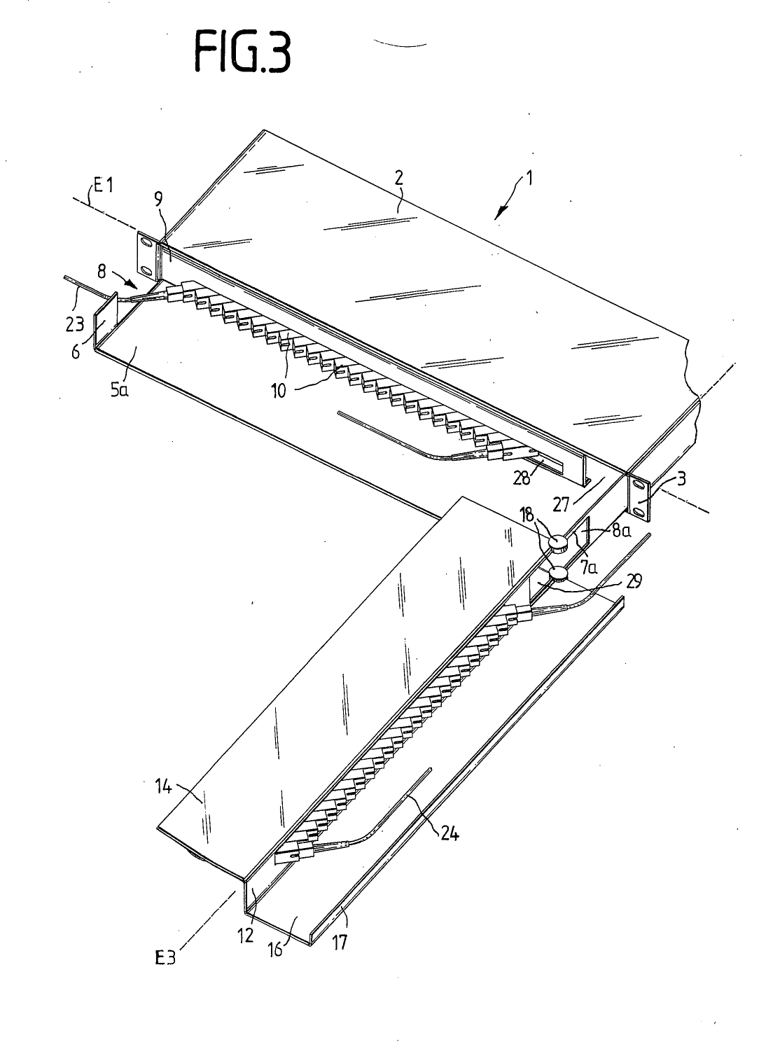

FIG. 3 shows a perspective front view of the patch panel with the second front panel pivoted open and with a cassette pulled in,

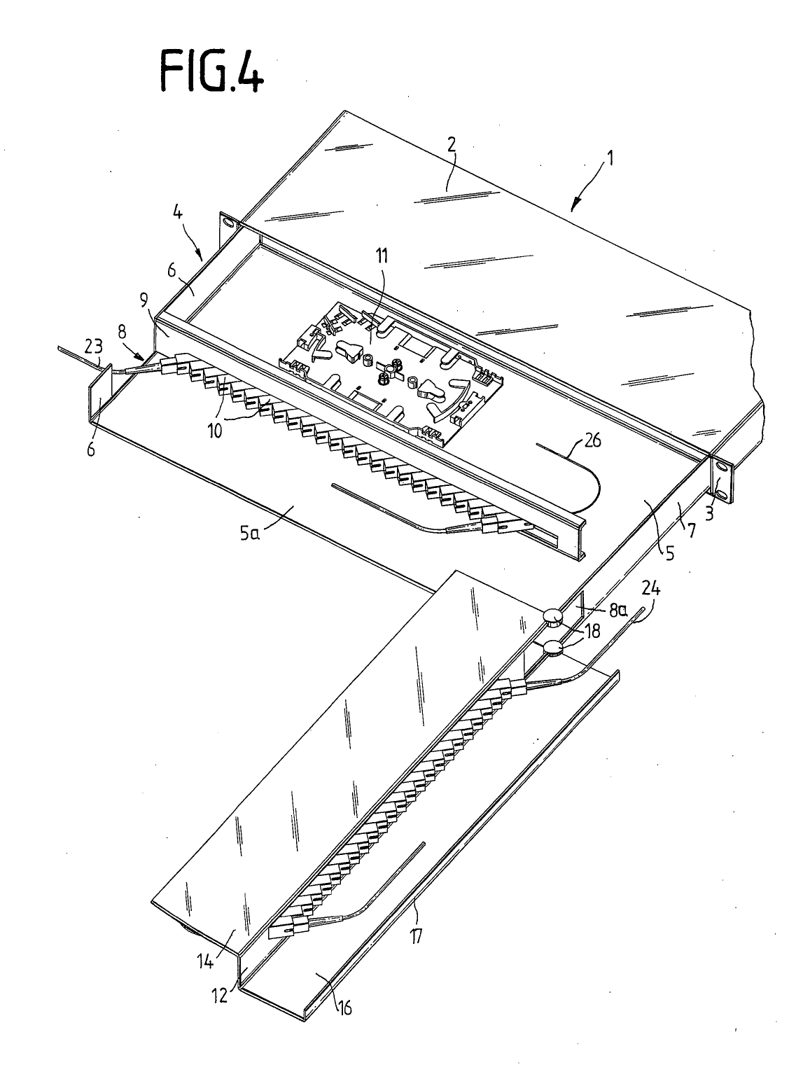

FIG. 4 shows a perspective front view of the patch panel with a cassette drawn out and with the second front panel pivoted open, and

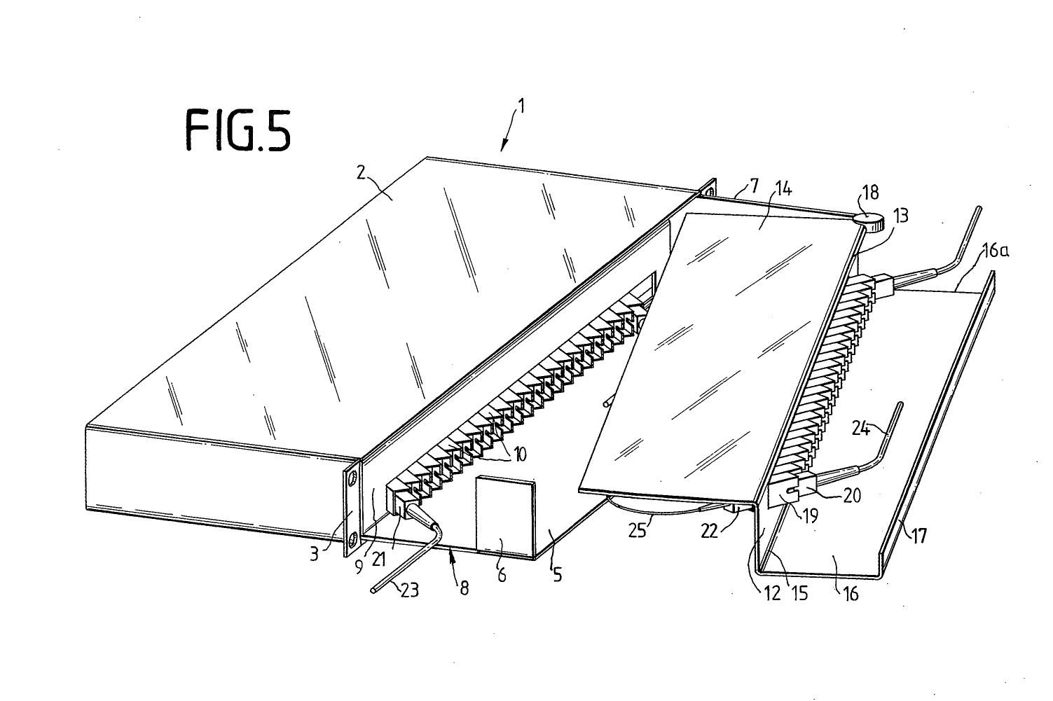

FIG. 5 shows a perspective side view with the second front panel partially pivoted open, and with a cassette pulled in.

FIGS. 1 to 5 show a patch panel 1 for an optical distribution frame in various working positions. The patch panel 1 comprises a housing 2 on which, in each case at the side, an attachment element 3 is arranged for attachment to a frame rack, which is not illustrated. A cassette 4 is arranged in the housing 2, which cassette 4 can be pulled out and, for example, is illustrated in the pulled-out state in FIGS. 2 and 4. The cassette 4 comprises a base plate 5 and side walls 6, 7, with the side wall 6 having a cutout 8 (FIGS. 3 to 5), and with the side wall 7 having a cutout 8a. Two webs 7a are formed by the cutout 8a on the side wall 7. A first front panel 9 is arranged on the side wall 6 and on the base plate 5 (see FIG. 4) and, when the cassette 4 is in the pulled-in state, ends with the housing edges of the housing 2. The base plate 5 in this case projects beyond the front panel 9 and forms a stowage surface 5a. The side walls 6, 7 are also lengthened beyond the front panel 9. The first front panel 9 has one or more openings 28 which are located alongside one another in a first row and into which couplings 10 are inserted at an angle of about 45°. Optical plugs 21 (see FIG. 5) can be inserted into the couplings 10 both from the front face and from the rear face of the first front panel 9. By way of example, a splicing cassette 11 (FIGS. 2 and 4) is arranged on the base plate 5 in the area behind the first front panel 9 and on the rear face of the front panel 9.

The patch panel 1 furthermore comprises a second front panel 12 on whose upper edge 13 a first element 14 is arranged, which is in the form of a plate and runs parallel to the base plate 5 (see FIG. 5). A second element 16 is arranged on a lower edge 15 of the second front panel 12, which second element 16 is in the form of a plate, extends forward and is located on the same plane as the base plate 5. The second element 16 which is in the form of a plate has a turned-over edge 17, which is directed upward and is once again aligned parallel to the front panel 12. In addition, the front panel 12 is narrower than the elements 14 and 16 which are in the form of plates, thus forming an opening 29. The second front panel 12 is articulated by means of a pivoting bearing 18 via two mutually opposite rotation points, such that it can pivot on the side wall 7, with the link to the side wall 7 being provided via the two webs 7a with the two elements 14, 16 which are in the form of plates. The second front panel 12 likewise has one or more openings, which are located alongside one another in a second row, for couplings 19, which are likewise positioned at an angle of about 45°, but with the couplings 10 of the first front panel 9 being rotated through 90° with respect to the couplings 19 of the second front panel 12, as a result of which the couplings 10 of the first front panel 9 are directed to the left in the direction of the cutout 8, and the couplings 19 of the second front panel 12 are directed to the right toward the right-hand side edge 16a. Furthermore, the couplings 19 in the second front panel 12 are located closer to the upper edge 13, that is to say the first and the second row of couplings 10, 19 have a height offset with respect to one another.

As already mentioned, optical plugs 20, 21, 22 can be inserted into the front face and rear face of the couplings 10, 19. In this case, by way of example, the plugs 20, 21 which are inserted into the front face of the couplings 10, 19 are a component of a patch cable 23, 24 while, in contrast, the plugs 22 which are inserted from the rear face are a component of a pigtail cable 25, 26 (see FIGS. 4 and 5). The pigtail cables 25 of the couplings 19 are preferably attached to the element 14 which is in the form of a plate, for example by being hooked in on hooks. The front of the coupling 19, the pigtail cables 25 or fibers are passed through an opening 28 in the front panel 9, or past it at the side to the splicing cassettes 11. In the illustrated exemplary embodiment (see FIG. 3), the first front panel 9 is narrower than the base plate 5, thus forming an opening 27 for the fibers between the front panel 9 and the side wall 7, through which opening 27 the fibers can then alternatively be passed. Since the second row of couplings 19 are located higher in the second front panel 12 than the first row of couplings 10 in the first front panel 9, the fibers of the pigtails 25 run from the couplings 19 above the patch cables 23 of the couplings 10.

FIG. 1 shows the patch panel 1 in a first working position, in which the cassette 4 (FIG. 2) has been pushed into the housing 2. The second front panel 12 lies on a plane E2 parallel to the plane E1 of the first front panel 9. The patch cables 24 of the second front panel 12 are passed away to the right to the right-hand side edge 16a, while the patch cables 23 of the first front panel 9 are passed out to the left through the cutout 8 (FIG. 3), corresponding to the inclined positions of the couplings 10. The two front panels 9, 12 have a height of precisely one height unit and are arranged to be coincident with one another, that is to say the patch panel 1 has precisely the same height as a patch panel according to the prior art. However, the patch panel 2 is deeper, specifically by the depth of the first element 14, which is in the form of a plate, and the second element 16, which is in the form of a plate. In this first working position, only the patch cables 24 with the optical plugs 20 arranged in the second front panel 12 are accessible.

FIG. 2 shows a second working position, in which the cassette 4 has been pulled out of the housing 2. In this position, the splicing cassettes 11 and the pigtail cables 25, 26 are also accessible, with the pigtail cables 25 being illustrated in FIG. 5. Furthermore, the couplings 10 which are held in the first front panel 5 are also accessible from the rear face.

FIG. 3 and FIG. 5 show a third working position, in which the second front panel 12 has been pivoted out onto a plane E3 at right angles to the first front panel 9. In this position, the patch cables 23 with the optical plugs 21 are accessible, which are arranged in couplings 10 of the first front panel 9. In this position as well, the couplings 19 which are arranged in the second front panel 14 are accessible, with their plugs 22, from the rear face.

FIG. 4 shows a fourth working position, in which the cassette 4 has been pulled out and the second front panel 12 has been pivoted onto the plane E3. Everything is freely accessible in this working position. In this case, it should be noted that the plane E3 need not be at right angles to the plane E1 but can also include a smaller or else a larger angle. It should also be noted that the housing 2 preferably has openings on the rear face, for optical cables to be fed through.

### LIST OF REFERENCE SYMBOLS

1 Patch panel
2 Housing
3 Attachment element
4 Cassette
5 Base plate
5a Stowage surface
6, 7 Side walls
7a Webs
8 Cutout
8a Cutout
9 Front panel
10 Couplings
11 Splicing cassette
12 Front panel
13 Upper edge
14 Element in the form of a plate
15 Lower edge
16 Element in the form of a plate
16a Right-hand side edge
17 Turned-over edge
18 Pivoting bearing
19 Couplings
20, 21, 22 Optical plugs
23, 24 Patch cables
25, 26 Pigtail cables
27 Opening
28 Openings
29 Opening
E1, E2, E3 Planes

1. A patch panel for an optical distribution frame, comprising a housing on whose front face a front panel is arranged having couplings or adapters for optical plug connectors, wherein
a second front panel having couplings or adapters for optical plug connectors is arranged in front of the front panel.

2. The patch panel as claimed in claim 1, wherein the second front panel is arranged on a plane parallel to the plane of the first front panel.

3. The patch panel as claimed in claim 1, wherein the second front panel can pivot with respect to the first front panel.

4. The patch panel as claimed in claim 1, wherein the first front panel is attached to a cassette, with the cassette being arranged on the housing such that it can be moved or pivoted.

5. The patch panel as claimed in claim 1, wherein the cassette has a base plate, with optical distribution frame and/or connecting elements being arranged on the base plate.

6. The patch panel as claimed in claim 5, wherein the base plate is lengthened over the front panel such that a stowage surface is formed in front of the first front panel.

7. The patch panel as claimed in claim 1, wherein an element which is in the form of a plate and runs parallel to the base plate is arranged on an upper edge of the second front panel.

8. The patch panel as claimed in claim 1, wherein a further element which is in the form of a plate is arranged on a lower edge of the second front panel and extends parallel to the first element which is in the form of a plate, in the direction of the front face.

9. The patch panel as claimed in claim 1, wherein the first and the second front panel each have the same height and are coincident, with the couplings or adapters of the second front panel being arranged offset in height with respect to the couplings or adapters of the first front panel.

10. The patch panel as claimed in claim 1, wherein the fibers of the rearward plugs of the second front panel are passed through an opening in the first front panel or at the side through an opening between the front panel and a side wall.

11. The patch panel as claimed in claim 10, the fibers are fixed between the couplings or adapters as far as a rotation point of a pivoting bearing.

12. The patch panel as claimed in claim 10, wherein the fibers are fixed behind the first front panel.
